(19) United States
(12) Patent Application Publication
(10) Pub. No.: US 2025/0321096 A1
(43) Pub. Date: Oct. 16, 2025

(54) STRUCTURAL DISPLACEMENT ESTIMATION METHOD AND SYSTEM THEREFOR

(71) Applicant: Korea Advanced Institute of Science and Technology, Daejeon (KR)

(72) Inventors: Hoon SOHN, Daejeon (KR); Zham Xiong MA, Daejeon (KR); Jae Mook CHOI, Daejeon (KR)

(73) Assignee: Korea Advanced Institute of Science and Technology, Daejeon (KR)

(21) Appl. No.: 18/869,367

(22) PCT Filed: Nov. 25, 2022
(86) PCT No.: PCT/KR2022/018878

§ 371 Date: Nov. 26, 2024

(30) Foreign Application Priority Data
Jun. 13, 2022 (KR) 10-2022-0071762

(51) Int. Cl. G01B 21/04; G01P 15/00; G01S 7/40; G01S 13/32; G01S 13/88

(52) U.S. Cl. CPC G01B 21/045; G01B 21/042; G01P 15/001; G01S 7/4004; G01S 13/32; G01S 13/88

(57) ABSTRACT

A structural displacement estimation method is performed by a computer program running on a computing device, and the program is configured to cause a processor of the device to perform an automated initial calibration may collect measured values respectively from a radar and an accelerometer installed directly at a structure, automatically determine a best target among candidate targets detected by the radar, and automatically calculate a final conversion factor to convert from a displacement in a line-of-sight direction for the best target to a displacement in an actual vibration direction, and a structural displacement monitoring may improve an accuracy of the structural displacement by calculating a final displacement by fusing based on a FIR-filter a radar-based displacement obtained by applying the final conversion factor to a phase extracted from the radar measured value of the best target and an accelerometer-based displacement obtained by double integrating the accelerometer measured value.

### TECHNICAL FIELD

Embodiments relate to a structural displacement estimation method, and more particularly, embodiments relate to a method for estimating a structural displacement at a desired point by installing a radar and an accelerometer at a desired structural displacement measurement point and fusing the measured values so as to estimate the displacement at the desired point.

### BACKGROUND ART

Displacement is vital for understanding a structure's behavior and current condition, so the displacement has been directly considered in structural design codes of many countries as a safety indicator of a structure. Excessive displacement caused by external loads may be used as a primary indicator that a structural stability is in danger, and may also be used for maintenance, management, and repair, such as improving numerical models or estimating damage.

However, unlike physical quantities such as acceleration, the displacement is difficult to measure in actual structures, so various methods such as linear variable differential transformer (“LVDT”), laser doppler velocimeter (“LDV”), indirect methods, or the like may be used to measure the displacement.

The LVDT, which is the most commonly used, is designed in proportion to a mechanical displacement of a core and an output voltage, resulting in high accuracy and reliability. However, since the LVDT requires a fixed point to install a sensor, an additional temporary structure is required to measure the displacement of an actual structure, and it is difficult to measure a displacement of bridges built on rivers and seas. The LDV is a non-contact sensor that may measure the displacement of the structure using a phase difference of reflected laser light. When measuring a center of the bridge because the laser light must be injected perpendicular to a surface of a measurement point, it is difficult to find the sensor installation point because a bottom of the measuring point is in the sea, and an equipment is very expensive, so it is not suitable to measure the displacement at the plurality of points at a same time.

The indirect method is a method of converting physical quantities such as the acceleration into the displacement. An accelerometer, a sensor that measures the acceleration, is installed on the structure, and the displacement may be easily estimated from the acceleration via double integration. While it has advantages of not requiring the fixed point for the sensor installation and is relatively inexpensive, however, there is a problem that a low-frequency component is greatly amplified due to a measurement noise. To solve this problem, a finite impulse response (“FIR”) filter method has been proposed, however, these methods do not clearly distinguish between the structure displacement and the noise in the actual low-frequency band, so a method of fusing the plurality of sensor data has been proposed.

On the other hand, it is also known how to measure the displacement of structures using a radar sensor. In this method, the radar sensor transmits a frequency-modulated signal, receives the reflected signal from the object, and estimates the displacement in a direction of a line-of-sight (“LOS”) from a time delay between the transmitted and received signals. However, a conventional radar-based displacement estimation method has following two problems. First, the radar sensor is installed at a fixed point other than the structure to be measured, and detects the plurality of targets on the structure. At this time, a position of each target detected by the radar sensor must be determined to select a best target that is most suitable for estimating the structural displacement, and an initial calibration is required to estimate a final conversion factor for conversion from the displacement in the line-of-sight direction (“LOS”) between the radar and the target to a displacement in actual vibration direction. However, in the past, these tasks were not automated and were done manually by a user. Manual initial calibration is cumbersome and reduces an accuracy and speed of the displacement estimation. Second, if a raw phase extracted from the radar measurements is outside a range of [−π, π], resulting in inaccurate displacement estimation by occurring phase wrapping. The phase wrapping may be a serious problem, especially when the structural displacement is greater than a wavelength of the radar.

### DISCLOSURE

### Technical Problem

Embodiments provide a structural displacement estimation method and a displacement estimation system for the same that may increase the accuracy of the displacement measurement by using measurement information together of the accelerometer and the radar sensor installed in the structure to be measured.

The embodiments are not limited to the embodiments mentioned above, and other embodiments not mentioned may be clearly understood by a person with ordinary knowledge in this technical filed from following descriptions.

### Technical Solution

In order to achieve the above purpose, a structural displacement estimation method according to an embodiment is performed by a computer program running on a computing device, the computer program may be configured to cause a processor of the computing device to perform an automated initial calibration step and a structural displacement monitoring step. The automated initial calibration step may be configured to collect measured values respectively from a radar and an accelerometer installed directly at a displacement measurement point of a structure, automatically determine one best target among a plurality of candidate targets detected by the radar, and automatically calculate a final conversion factor to convert from a displacement in a line-of-sight direction of the displacement measurement point for the best target to a displacement in an actual vibration direction. The structural displacement monitoring step may be configured to calculate a final displacement by fusing based on a FIR-filter a radar-based displacement obtained by applying the final conversion factor to a phase extracted from the measured value from the radar of the best target, and an accelerometer-based displacement obtained by double integrating the measured value from the accelerometer.

In an embodiment, the measurement using the radar and the measurement using the accelerometer may be carried out for a same period of time.

In an embodiment, the measurement using the radar and the measurement using the accelerometer may be carried out in less than one minute.

In an embodiment, the radar and the accelerometer may collect the measured values which may be installed in close proximity to each other at the displacement measurement points of the structure.

In an embodiment, the automated initial calibration step may include measuring an initial displacement in the line-of-sight direction of the displacement measurement point for each of the plurality of candidate targets using the radar, calculating a plurality of first displacements in the vibration direction by applying a plurality of conversion factor values to the initial displacement for each of the plurality of candidate targets, measuring an acceleration of the displacement measurement point with the accelerometer, calculating a second displacement by double integrating the acceleration, calculating RMSE between each of the plurality of first displacements calculated for each of the plurality of candidate targets and the second displacement, and determining a minimum value among the calculated RMSE values as a minimum RMSE value of the candidate target, automatically determining a candidate target having a smallest minimum RMSE value among the plurality of minimum RMSE values determined for each of the plurality of candidate targets as the best target, and automatically calculating a conversion factor applied to obtain the minimum RSME value of the best target as a final conversion factor of the best target.

In an embodiment, the plurality of conversion factor values may be within a range of 0.5 to 2.0.

In an embodiment, in the structural displacement estimation method, the structural displacement monitoring step may be periodically performed by performing the displacement measurement periodically using the radar and the accelerometer for the best target automatically determined in the automated initial calibration step.

In an embodiment, the structural displacement monitoring step may include extracting raw phase by performing the radar measurement for the best target using the radar, measuring the acceleration of the displacement measurement point with the accelerometer and calculating the acceleration-based displacement by double integrating the measured acceleration, when a phase wrapping problem occurs in the raw phase due to the displacement of the displacement measurement point of the structure being greater than a wavelength of a radar signal of the radar, selecting an unwrapping phase close to a predicted phase using the measured acceleration, calculating a third displacement in the line-of-sight direction using a raw phase without the phase wrapping problem or the unwrapping-processed phase due to phase wrapping problem, calculating the radar-based displacement in the vibration direction by applying the final conversion factor to the third displacement in the line-of-sight direction, and calculating the final displacement by fusing the acceleration-based displacement and the radar-based displacement using the finite impulse response (“FIR”) filter.

In an embodiment, the step of calculating the final displacement may include obtaining a radar-based low-frequency displacement by performing low-pass filtering on the radar-based displacement, obtaining an acceleration-based high frequency displacement by performing high-pass filtering on the acceleration-based displacement, and calculating the final displacement by fusing the radar-based low-frequency displacement and the acceleration-based high frequency displacement.

In an embodiment, the step of selecting the unwrapping phase may include using a displacement at (k−1)th and (k−2)th time steps and a (k−1)th acceleration, each of a predicted displacement (ûₖ) and a predicted phase (\hat{φ}ₖ) at kth time step are calculated by Equation ûₖ=2uₖ₋₁−uₖ₋₂+(Δt)²aₖ₋₁ and Equation

$${\hat{φ}}_{k} = 4 π {f}_{s} \frac{{\hat{u}}_{k}}{β c} ;$$

and finding an unwrapping phase within the ±2pπ range (where the p is an integer) of the raw phase and closest to the predicted phase by Equation

$${\overline{φ}}_{k} = {φ}_{k} + 2 π \times round ( \frac{{\hat{φ}}_{k} - {φ}_{k}}{2 π} ) ,$$

and selecting as a phase to be used to estimate the radar-based displacement.

In an embodiment, the final displacement may be calculated using a formula u*ₖ=C_{H}a+C_{L}u(C_{H}: double integration and (2M+1)th order high-pass filter, a: measurement acceleration vector, C_{L}: (2M+1)th order low-pass filter, u: radar-based displacement vector).

In an embodiment, the radar may be a frequency modulation continuous wave radar signal (FMCW) millimeter wave radar, and a frequency modulation continuous signal may transmit a chirp signal, receive a signal reflected from the target candidate group, and estimate the displacement in the line-of-sight direction using a signal round-trip time between the transmit and receive signals.

A structural displacement estimation system according to another embodiment includes a radar installed directly at a displacement measurement point of a structure, configured to transmit radar signals toward a plurality of candidate targets that do not change position, and configured to receive reflected signals reflected from the plurality of candidate targets, an accelerometer installed at the displacement measurement point of the structure and configured to measure acceleration at the displacement measurement point of the structure, and a displacement estimator configured to perform an automated initial calibration function configured to collect measured values respectively from a radar and an accelerometer, automatically determine one best target among a plurality of candidate targets detected by the radar, automatically calculate a final conversion factor to convert from a displacement in a line-of-sight direction of the displacement measurement point for the best target to a displacement in an actual vibration direction, and a structural displacement monitoring function configured to calculate a final displacement by fusing based on a FIR-filter a radar-based displacement obtained by applying the final conversion factor to a phase extracted from the measured value from the radar of the best target, and an accelerometer-based displacement obtained by double integrating the measured value from the accelerometer.

In an embodiment, the displacement estimator may include a computer program written to perform the automated initial calibration function and the structural displacement monitoring function and a processor executing the computer program.

In an embodiment, when a wrapping problem occurs the phase due to a displacement of the displacement measurement point of the structure being greater than a wavelength of the radar signal, the displacement estimator may be further configured to perform a phase unwrapping processing function to estimate a radar-based displacement by selecting an unwrapping phase closest to a predicted phase using a measured acceleration at the structure.

In an embodiment, the automated initial calibration function may include a function of measuring an initial displacement in the line-of-sight direction of the displacement measurement point for each of the plurality of candidate targets using the radar, a function of calculating a plurality of first displacements in the vibration direction by applying a plurality of conversion factor values to the initial displacement for each of the plurality of candidate targets, a function of measuring an acceleration of the displacement measurement point with the accelerometer, a function of calculating a second displacement by double integrating the acceleration, a function of calculating RMSE between each of the plurality of radar-based first displacements calculated for each of the plurality of candidate targets and the second displacement, and determining a minimum value among the calculated RMSE values as a minimum RMSE value of the candidate target, a function of automatically determining a candidate target having a smallest minimum RMSE value among the plurality of minimum RMSE values determined for each of the plurality of candidate targets as the best target, and a function of automatically calculating a conversion factor applied to obtain the minimum RSME value of the best target as a final conversion factor of the best target.

In an embodiment, the structural displacement monitoring function may include a function of extracting raw phase by performing the radar measurement for the best target using the radar, a function of measuring the acceleration of the displacement measurement point with the accelerometer and calculating the acceleration-based displacement by double integrating the measured acceleration, when a phase wrapping problem occurs the raw phase due to a displacement of the displacement measurement point of the structure being greater than a wavelength of the radar signal, a function of selecting an unwrapping phase close to a predicted phase using the measured acceleration, a function of calculating a third displacement in the line-of-sight direction using a raw phase without the phase wrapping problem or the unwrapping-processed phase due to phase wrapping problem, a function of calculating the radar-based displacement in a vibration direction by applying the final conversion factor to the third displacement in the line-of-sight direction, and a function of calculating the final displacement by fusing the acceleration-based displacement and the radar-based displacement using the finite impulse response (FIR) filter.

In an embodiment, the function of the calculating the final displacement may include a function of obtaining a radar-based low-frequency displacement by performing low-pass filtering on the radar-based displacement, a function of obtaining an acceleration-based high frequency displacement by performing high-pass filtering on the acceleration-based displacement, and a function of calculating the final displacement by fusing the radar-based low-frequency displacement and the acceleration-based high frequency displacement.

### Advantageous Effects

According to a structural displacement estimation method according to exemplary embodiments of the disclosure, the radar and the accelerometer may be installed directly on the structure, so additional fixed point positioned outward the structure does not need, the initial calibration including selecting best target required for estimating the radar based displacement and estimating final conversion factor may proceed automatically, so time, human resource, and cost may be reduced.

In addition, solving the phase wrapping problem using the accelerometer, and the estimated displacement based on the unwrapping phase may be fused with the measured acceleration based on the FIR filter to calculate the final displacement more accurately, allowing continuous structural displacement estimation monitoring.

However, the effect of the embodiments is not limited to the above-mentioned effect, and may be expanded in various ways within the scope of the idea and scope of the embodiments.

### DESCRIPTION OF DRAWINGS

FIG. 1 schematically shows an embodiment in which a structural displacement estimation system according to embodiments of the disclosure is installed in a bridge structure.

FIG. 2 is an enlarged view of a part A of FIG. 1.

FIGS. 3(A) and 3(B) show embodiments of a signal waveform of the radar 20 included in the structural displacement estimation system of FIG. 1 expressed as a time function for a frequency and an amplitude, respectively.

FIG. 4 is a flowchart illustrating a method for estimating the displacement of the structure using the structural displacement estimation system of FIG. 1.

FIG. 5 is a flowchart detailing the automated initial calibration steps included in the method of estimating the displacement of the structure in FIG. 4.

FIG. 6 is a flowchart illustrating the structural displacement monitoring steps included in the method of estimating the displacement of the structure in FIG. 4.

FIG. 7 is a view illustrating the accelerometer 30 auxiliary phase unwrapping algorithm applied to the method of estimating the displacement of the structure of FIG. 4.

FIGS. 8(A) and 8(B) are views illustrating the steps of automatically determining the best target and automatically calculating the final conversion factor in the method of estimating the displacement of the structure in FIG. 4, respectively.

FIG. 9 is a view illustrating the step of fusing based on the FIR filter of FIG. 6 to calculate the final displacement.

FIG. 10 is a configuration layout for the short-range simulation.

FIG. 11 is a view illustrating the estimated displacement according to a vibration magnitude.

FIG. 12 is a result of calculating final conversion factor and an error of the estimated displacement by applying the final conversion factor.

FIG. 13 is a configuration layout for long-range simulation.

FIG. 14 is a view illustrating the automated initial calibration step.

FIG. 15 is a calculating result of the unwrapping algorithm and the error of the estimated displacement by applying the unwrapping algorithm.

FIG. 16 is a configuration layout for simulation of the structure caused by the walking of the pedestrian.

FIG. 17(A) is a view illustrating the automated initial calibration step, and FIG. 17(B) is the result of calculating the estimated displacement error for each target.

FIG. 18 is a view illustrating the estimated displacement according to the vibration magnitude.

FIG. 19 is a view illustrating the raw phase and unwrapping phase of FIG. 18(B).

### BEST MODE

Hereinafter, preferred embodiments of the disclosure will be described in more detail with reference to the accompanying drawings. The same reference numerals are used for the same components in the drawings, and redundant descriptions of the same components will be omitted.

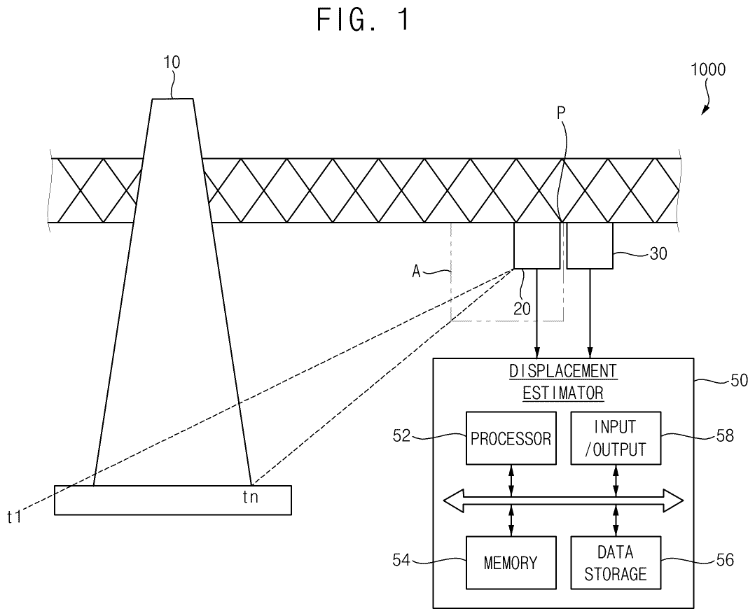

FIG. 1 schematically shows an embodiment in which a structural displacement estimation system according to embodiments of the disclosure is installed in a bridge structure.

Referring to FIG. 1, a structural displacement estimation system 1000 according to an embodiment of the disclosure may include a radar (radio detection and ranging) 20 and an accelerometer 30 as a measuring means to measure a displacement of the a structure 10, which is a target of displacement measurement. In addition, the structural displacement estimation system 1000 may also include a displacement estimator 50 that receives measurement signals from the radar 20 and the accelerometer 30 and performs operations to estimate the displacement of structure 10.

In FIG. 1, the bridge is illustrated as the structure 10 to which the displacement is estimated, and there is no particular limitation on a type of the structure to which the disclosure may be applied.

The radar 20 may be installed directly at a displacement measurement point P of the structure 10, transmit radar 20 signals toward a plurality of candidate targets t1 . . . tn that do not change position, and receive reflected signals reflected from the plurality of candidate targets.

The accelerometer 30 may be installed at the displacement measurement point P of the structure 10, and measure acceleration at the displacement measurement point P of the structure 10. In other words, the radar 20 and the accelerometer 30 may be installed in close proximity to each other at the displacement measurement point P of the structure 10 so that each of the radar 20 and the accelerometer 30 may collect measured values.

The displacement estimator 50 may be communicatively connected to the radar 20 and the accelerometer 30 with each other by wired, wireless or wired and wireless communication, respectively. The displacement estimator 50 may be configured to calculate an estimate of the displacement of the structure 10 by providing a radar 20 measurement data provided from the radar 20 (obtained through a transmit signal processing of the radar 20 reflected from the structure 10) and an acceleration data of the structure 10 provided by the accelerometer 30 through the communication.

The displacement estimator 50 may include a computer program written to perform an automated initial calibration function (S100) and a structural displacement monitoring function (S200) and a processor 52 executing the computer program. In addition, when a wrapping problem occurs the phase due to a displacement of the displacement measurement point of the structure being greater than a wavelength of the radar 20 signal, the computer program of the displacement estimator 50 may be further configured to perform a phase unwrapping processing function to estimate a radar-based displacement by selecting an unwrapping phase closest to a predicted phase using a measured acceleration at the structure 10.

Hardware resources for the displacement estimator 50 may include a computing device including the processor 52. In addition to the processor 52, the computing device may include memory 54, non-volatile storage device data storage 56, input/output 58, or the like. For example, the hardware of the displacement estimation 50 may include a general-purpose computer including the above means or a computing device dedicated to the disclosure, workstation device, or the like.

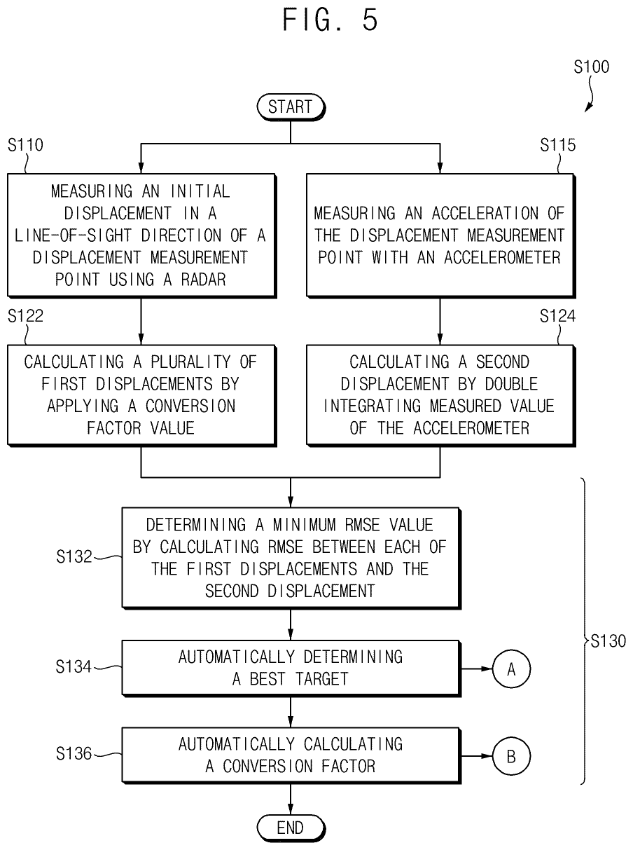

The processor 52 may perform an automated initial calibration function configured to automatically determine one best target (A of FIG. 5) among the plurality of candidate targets t1 . . . tn detected by the radar 20, automatically calculate a final conversion factor B to convert from a displacement in a line-of-sight direction of the displacement measurement point D for the best target A to a displacement in an actual vibration direction D, and a structural displacement monitoring function configured to calculate a final displacement by fusing based on a FIR-filter a radar-based displacement obtained by applying the final conversion factor B to a phase extracted from the measured value from the radar 20 of the best target A, and an accelerometer-based displacement obtained by double integrating the measured value from the accelerometer 30.

The automated initial calibration function may include a function of measuring an initial displacement in the line-of-sight direction of the displacement measurement point for each of the plurality of candidate targets using the radar 20, a function of calculating a plurality of first displacements in the vibration direction by applying a plurality of conversion factor values to the initial displacement for each of the plurality of candidate targets, a function of measuring an acceleration of the displacement measurement point with the accelerometer 30, a function of calculating a second displacement by double integrating the acceleration, a function of calculating RMSE between each of the plurality of radar-based first displacements calculated for each of the plurality of candidate targets and the second displacement, and determining a minimum value among the calculated RMSE values as a minimum RMSE value of the candidate target, a function of automatically determining a candidate target having a smallest minimum RMSE value among the plurality of minimum RMSE values determined for each of the plurality of candidate targets as the best target A, and a function of automatically calculating a conversion factor applied to obtain the minimum RSME value of the best target A as a final conversion factor B of the best target A.

The structural displacement monitoring function may include a function of extracting raw phase by performing the radar 20 measurement for the best target A using the radar 20, a function of measuring the acceleration of the displacement measurement point with the accelerometer 30 and calculating the acceleration-based displacement by double integrating the measured acceleration, when a phase wrapping problem occurs the raw phase due to a displacement of the displacement measurement point of the structure 10 being greater than a wavelength of the radar 20 signal of the radar 20, a function of selecting an unwrapping phase close to a predicted phase using the measured acceleration, a function of calculating a third displacement in the line-of-sight direction using a raw phase without the phase wrapping problem or the unwrapping-processed phase due to phase wrapping problem, a function of calculating the radar-based displacement in a vibration direction by applying the final conversion factor B to the third displacement in the line-of-sight direction, and a function of calculating the final displacement by fusing the acceleration-based displacement and the radar-based displacement using the finite impulse response (FIR) filter.

On the other hand, the function of selecting the unwrapping phase may be a function of obtaining a radar-based low-frequency displacement by performing low-pass filtering on the radar-based displacement, a function of obtaining an acceleration-based high frequency displacement by performing high-pass filtering on the acceleration-based displacement, and a function of calculating the final displacement by fusing the radar-based low-frequency displacement and the acceleration-based high frequency displacement.

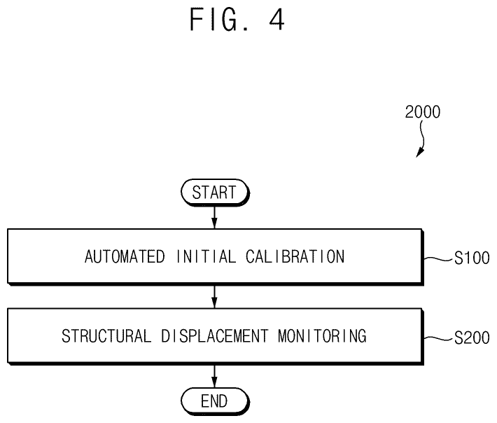

Detailed descriptions of the automated initial calibration function, the structural displacement monitoring function, and the phase unwrapping processing function will be described below with reference to FIGS. 4 to 9, respectively.

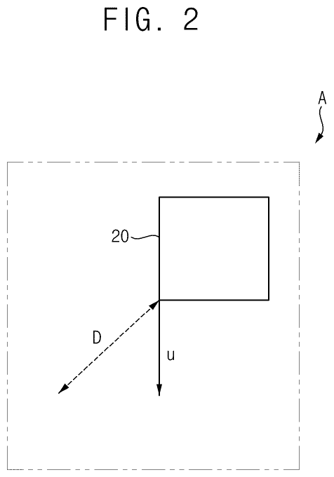

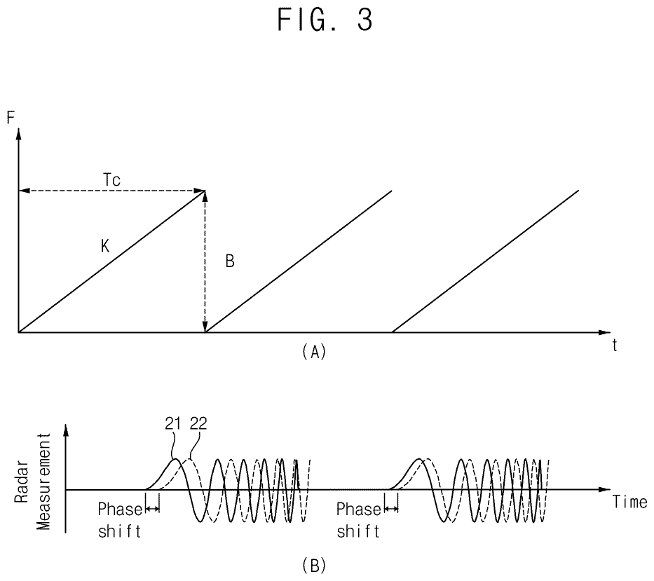

FIG. 2 is an enlarged view of a part A of FIG. 1, FIGS. 3(A) and 3(B) show embodiments of a signal waveform of the radar 20 included in the structural displacement estimation system of FIG. 1 expressed as a time function for a frequency and an amplitude, respectively.

Referring to FIG. 2, a distance D between the radar 20 and any target may be expressed as follows:

$$D = \frac{c Δ t}{2} \qquad [ Equation 1 ]$$

In Equation. 1, c represents a speed of light, and Δt represents a signal round-trip time. Detailed descriptions of the Δt will be described below with reference to FIG. 3B, and Equations 2 and 3.

In an exemplary embodiment, the radar 20 may be FMCW radar 20. In the structure displacement estimation system 1000, the FMCW radar 20 installed in the structure 10 may transmit a modulation frequency signal in a millimeter-wave band, receive a signal reflected from the target (object), convert it into a digital signal through predetermined signal processing, and provide it to the displacement estimator 50. The displacement estimator 50 may process the digital signal, calculate a phase, and convert it to displacement. (i.e., from time delay between a transmitting signal and a received signal, the displacement in the line-of-sight (“LOS”) direction D may be estimated. At the same time, the accelerometer 30 may convert an acceleration signal to the displacement by double integrating. Then, the displacement estimator 50 may fuse the displacements to estimate a final displacement of the structure 10.

The modulated frequency signal transmitted from the FMCW radar 20 may be reflected from a plurality of candidate targets t1 . . . tn, and an initial calibration process may be required to determine the best target A to estimate radar-based displacement.

The plurality of candidate targets t1 . . . tn may include targets that are fixed and do not change position. For example, objects such as large rocks, piers on bridges, or the like may be selected as the target.

The distance between the FMCW radar 20 and the target may include displacement information in the line-of-sight direction D of the displacement measurement point. However, the direction of the displacement (vibration) of the structure 10 due to external force may be arbitrary, so that the direction of the line-of-sight D and the actual vibration direction may be different. A conversion factor may be required to convert the displacement in the line-of-sight direction D of the structure 10 to the actual (vibration) displacement u.

Detailed descriptions of the initial calibration step of selecting the best target A and estimating the final conversion factor B will be described below with reference to FIG. 5.

Referring to FIG. 3(A), the FMCW radar 20 may use a chirp signal. For example, the chirp signal may have a waveform that increases in frequency as time increases.

Referring to FIG. 3(B), the FMCW radar 20 may transmit the modulated frequency signal 21 and receive the reflected signal 22 from the target. The transmitting signal (T(t), 21) corresponds to a solid line, and the reflected signal (R(t), 22) corresponds to a dotted line.

The reflected signal 22 may be a time-delayed version of the transmitting signal 21, as shown in FIG. 3(B). The transmitting signal 21 and the reflected signal 22 for a single target may be expressed as follows:

$$T ( t ) = \text{?} \qquad [ Equation 2 ]$$

$$R ( t ) = δ T ( t - Δ t ) = δ \text{?} \qquad [ Equation 3 ]$$

$$\text{?} \text{indicates text missing or illegible when filed}$$

In Equations 2 and 3, fₛ, K, T_{c} and δ represent a start Frequency (Fs), Slope (K), Chirp duration (Tc), and amplitude attenuation factors of the chirp signal, respectively.

The signal round-trip time Δt required to calculate the displacement in the line-of-sight direction D may be extracted from the intermodulation frequency signal (Intermodulation Frequency (IF), w) or phase (ϕ).

The signal round-trip time Δt required to calculate the displacement in the line-of-sight direction D may be extracted from an intermodulation Frequency (IF, w) or a phase (φ).

The intermodulation frequency signal may be generated by a mixer by combining the transmit signal 21 and the reflected signal 22. The intermodulation frequency signal may be expressed as follows:

$$IF ( t ) = T ( t ) \times \text{?} ( t ) \approx δ \text{?} , 0 < t < {T}_{c} \qquad [ Equation 4 ]$$

$$ω = 2 π K Δ t$$

$$φ = 2 π {f}_{s} Δ t$$

$$\text{?} \text{indicates text missing or illegible when filed}$$

In Equation. 4, R*(t) represents a conjugate complex number of R(t).

By combining equations 1 and 4, the displacement in the line-of-sight direction of the displacement D measurement point for a single target may be estimated as follows:

$$D = \frac{c}{4 π K} ω = \frac{c}{4 π {f}_{s}} φ . \qquad [ Equation 5 ]$$

As shown in FIG. 1, the radar 20 may detect the plurality of candidate targets t1 . . . tn. Thus, the displacement in the line-of-sight direction D of the displacement measurement point may be estimated at several values.

The reflected signal 22 and the intermodulation frequency signal used for estimating the displacement in the line-of-sight direction D of the displacement measurement point may be expressed as follows.

$$R ( t ) = {\sum }_{m = 1}^{Q} {δ}^{m} \text{?} \qquad [ Equation 6 ]$$

$$IF ( t ) \approx {\sum }_{j = 1}^{Q} {δ}^{m} \text{?} \qquad [ Equation 7 ]$$

$${ω}^{m} = 2 π K Δ {t}^{m}$$

$${φ}^{m} = 2 π {f}_{s} Δ {t}^{m}$$

$$\text{?} \text{indicates text missing or illegible when filed}$$

In Equations 6 and 7, Q, m, δ^{m} and Δt^{m} represent a total target number included in the plurality of candidate targets t1 . . . tn, target index, the amplitude attenuation factor of mth target, and the signal round-trip time Δt between the transmitting signal 21 and the signal reflected from the mth target, respectively.

The distance D between the plurality of candidate targets t1 . . . tn and the radar 20 may be converted to IF tones, respectively. Referring to Equation. 1, the distance D between the radar 20 and the target may be proportional to the signal round-trip time Δt. Therefore, the signal round-trip time Δt may be delayed in proportion to the distance, and the IF, consisting of several tons, may be obtained as much as the time delay. It may be processed using Fast Fourier Transform (“FFT”) to differentiate between the IFs composed of the plurality of tones. After processing the FFT, a frequency spectrum may be generated in which individual peaks for different tones appear, and each peak may represent a target present at a certain distance.

In summary, the displacement in the line-of-sight direction D of the displacement measurement point from the frequency or the phase may be expressed as follows:

$${D}^{m} = \frac{c}{4 π K} {ω}^{m} = \frac{c}{4 π {f}_{s}} {φ}^{m} \qquad [ Equation 8 ]$$

Below, with reference to FIGS. 4 to 9, a structural displacement estimation method 2000 that may be performed by a computer program running on a computing device will be described in detail.

FIG. 4 is a flowchart illustrating a method for estimating the displacement of the structure using the structural displacement estimation system of FIG. 1.

Referring to FIG. 4, the computer program may cause the processor 52 of the computing device to perform the structural displacement estimation method 2000 including an automated initial calibration step (S100) and a structural displacement estimation step (S200).

The automated initial calibration step (S100) may collect measurements from the radar 20 and the accelerometer 30 installed directly at the displacement measurement point of the structure 10, respectively, and automatically determine the one best target A among the plurality of candidate targets t1 . . . tn detected by the radar 20, and automatically calculate the final conversion factor B to convert from the displacement in the line-of-sight direction of the displacement measurement point for the best target A to a displacement in an actual vibration direction u.

The automated initial calibration step (S100) may automatically select the best target, and automatically calculate the final conversion factor B by collecting measurement using the radar 20 and the accelerometer 30 for a predetermined time (e.g., a short time of less than one minute) initially.

The radar 20 may automatically detect the plurality of targets. Conventionally, a problem of large structural displacement error estimation by selecting a wrong target has been caused, however, the structural displacement estimation method 2000 according to an embodiment of the disclosure may use a most suitable best target A among the plurality of candidate targets t1 . . . tn, which may automatically determine by the radar-based displacement.

In addition, since the distance between the radar 20 and the best target A is the displacement in the line-of-sight direction D of the displacement measurement point, it is necessary to convert the displacement in the line-of-sight direction D to the displacement in the actual vibration direction u causing the displacement of the structure 10. Conventionally, the conversion factor was calculated manually through geometric calculations, however, the structural displacement estimation method 2000 according to an embodiment of the disclosure may automatically calculate the final conversion factor B in the automated initial calibration step (S100).

By periodically performing the displacement measurements using the radar 20 and the accelerometer 30 for the best target A automatically determined in the automated initial calibration step (S100), the structural displacement monitoring step (S200) may be performed periodically.

The structural displacement monitoring step (S200) may be performed to calculate the final displacement by fusing based on the FIR filter the radar-based displacement obtained by applying the final conversion factor B to the phase extracted from the radar 20 measurements for the best target A and the acceleration-based displacement obtained by double integrating the accelerometer 30 measurements.

The structural displacement monitoring step (S200) may obtain the displacement in the line-of-sight direction D at the phase extracted from the radar 20 measurements for the automatically selected the best target A, then the final conversion factor B may be applied to the displacement to obtain the radar-based displacement in the vibration direction of the measurement point P, and the acceleration-based displacement may be obtained by double integrating the measured values collected by the accelerometer 30. Then, by fusing based on the FIR filter the radar-based low-frequency displacement with low-pass filtering of the radar-based displacement and the acceleration-based high frequency displacement with high-pass filtering of the acceleration-based displacement, and the final displacement with greater accuracy may be calculated than the estimated displacement using the radar 20 or the accelerometer 30 alone.

FIG. 5 is a flowchart detailing the automated initial calibration steps included in the method of estimating the displacement of the structure in FIG. 4.

Referring to FIG. 5, the automated initial calibration (S100) may include steps to measure each of the radar 20 and the accelerometer 30, to calculate plurality of first displacements by applying conversion factor β value to the radar 20 measurement value (S110, S115), the steps to calculate the second displacement by double integrating the accelerometer 30 measurement values (S122, S124), and the steps to automatically determine the best target A and to automatically calculate the conversion factor (S130).

First, the steps (S110, S115) may be performed to measure each of the radar 20 and the accelerometer 30.
an initial displacement in the line-of-sight of the displacement measurement point P of each of the plurality of candidate targets t1 . . . tn, may be measured using the radar 20 (S110), and the acceleration of the displacement measurement point P may be measured by the accelerometer 30 (S115).

The plurality of targets may exist within a detection range of the radar 20. Since the accuracy of the measurements provided by the targets may vary, it is advisable to choose the best target A that guarantees the most accurate measurement among them. The displacement value of the measurement point measured by the accelerometer 30 may be the criterion for selecting the best target A. In other words, for each of the plurality candidate targets, the displacement may be calculated using the radar 20 and the accelerometer 30, and the candidate target with the smallest difference between the calculated two displacements may be selected as the best target A. The signal processing process for the same will be described in detail.

During a predetermined measurement time, the radar 20 may detect the plurality of target candidates t1 . . . tn and select any one target (e.g., the target 1), and perform measurements on the selected target by radar 20 (S110). During a same measurement time as the radar 20 transmits the radar 20 signal to the target 1 and receives reflected signal to measure phase, the accelerometer 30 may measure the acceleration at the same measurement point in the same measurement time (S115). The displacement measurements using the radar 20 and the accelerometer 30 may be performed independently. As described before with reference to FIG. 1, the radar 20 and the accelerometer 30 may be installed in close proximity to each other at the displacement measurement point of the structure 10 and the measured values may be collected.

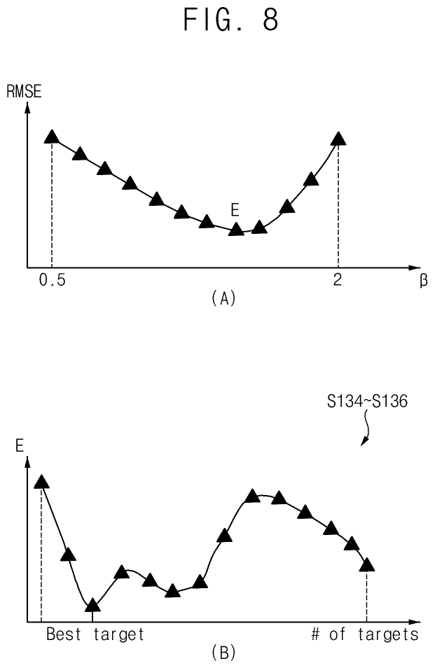

A number of initial conditions required for the automated initial calibration step (S100) may be set. For example, an initial value of the conversion factor (β of FIG. 8) may be set to a predetermined size. A variable range of the conversion factor β may also be set. In an embodiment, the conversion factor β may be set to a value within the range of 0.5 to 2. When the conversion factor β is 1, the accuracy of estimating the distance between the radar 20 and the target may be estimated to be the greatest. If the conversion factor β is outside the change range of from 0.5 to 2, a strength of the radar 20 reflected signal may weaken and the estimation accuracy may be lowered, so it is set to the value within the above range.

A time of one cycle of performing the radar 20 measurements and the acceleration measurements may also be set. Measurements using the radar 20 and measurements using the accelerometer 30 may be performed for the same time. In an embodiment, the measurements using the radar 20 and the accelerometer 30 may be performed in less than one minute. A maximum of one minute of measurement is sufficient to collect the data to perform the initial calibration.

Next, the conversion factor β value may be applied to the radar 20 measurement value to calculate the plurality of first displacements, and the step of calculating the second displacement by double-integrating the accelerometer 30 measurement value may include a step in which the plurality of conversion factor β values may be applied to the initial displacement to calculate the plurality of first displacements in the vibration direction (S122) and the second displacement may be calculated by the double integration of the acceleration (S124).

The displacement in the line-of-sight direction D of the displacement measurement point P may be measured for each of the plurality of candidate targets t1 . . . tn using the radar 20. The displacement in the line-of-sight direction D may be defined as the initial displacement. Thereafter, the plurality of first displacements may be calculated by applying the plurality of transformation coefficient factor β to the initial displacement for each of the plurality of candidate targets t1 . . . tn. The first displacement may be defined as the displacement u in the vibration direction.

On the other hand, the accelerometer 30 measurement may be calculated by double integrating the second displacement of the measurement point P.

Finally, the step of automatically determines the best target A and automatically calculates the conversion factor (S130) may include, calculate RMSE between each of the plurality of first displacements calculated for each of the plurality of candidate targets t1 . . . tn and the second displacement, determine a minimum value among the calculated RMSE values as a minimum RMSE value of the candidate target (S132), automatically determining a candidate target having a smallest minimum RMSE value among the plurality of minimum RMSE values determined for each of the plurality of candidate targets as the best target A (S134), and automatically calculate the conversion factor applied to obtain the minimum RSME value of the best target A as a final conversion factor B of the best target (S136).

High-pass filtering may be performed on the first and second displacements to obtain the first high frequency displacement and the second high frequency displacement. When measuring the acceleration of the structure 10 and integrating it in a time domain to calculate the second displacement, an initial velocity uncertainty of the actual structure 10, a noise of the measurement signal accumulate in a time integration process, and low frequency drift occurs, and the calculated second displacement value is diverted. Therefore, high-pass filtering may be performed to counteract these low frequency drift effects. During performing the high-pass filtering, cut-off frequency may be set to about 0.5 Hz.

By calculating the RMSE between the high-pass filtered first and second high frequency displacements (S132), the best target A may be automatically determined (S134), and the final conversion factor B may also be automatically calculated (S136). Detailed descriptions of the steps (S132, S134, S136) in which automatically determine the best target A by calculating the RMSE and automatically calculating the final conversion factor B will be described below with reference to FIG. 8.

FIGS. 8(A) and 8(B) are views illustrating the steps of automatically determining the best target and automatically calculating the final conversion factor in the method of estimating the displacement of the structure in FIG. 4, respectively.

Referring to FIG. 8(A), the RMSE between each of the first and second displacements may be calculated with a gradual increase in the conversion factor β (S132).

For each of the plurality of candidate targets, the RMSE between the first displacement calculated by applying the plurality of conversion factor β values to the initial displacement measured using the radar 20 and the second displacement calculated by double integrating the accelerometer 30 measurements may be calculated, and a correlation between the RMSE and the conversion factor β may be obtained. The plurality of conversion factor values may be selected within the range of 0.5 to 2.0.

An error function (“RMSE”) may be defined as follows:

$$RMSE = \sqrt{\frac{1}{N} \text{?} {( pred - {target}_{i} )}^{2}} \qquad [ Equation 9 ]$$

$$\text{?} \text{indicates text missing or illegible when filed}$$

Specifically, the RMSE between the above radar 20-based displacement and the accelerometer 30-based displacement may be calculated for a randomly selected target 1.

In this case, the RMSE calculation may be performed repeatedly with a gradual increase in the conversion factor β from the initial value of 0.5 to 2. Through this, the RMSE values as the conversion factor β value increases may be obtained for the target 1.

As shown in FIG. 8(A), the RMSE values with the increase in the conversion factor β value may be graphed and a conversion factor value E corresponding to the minimum RMSE value may be selected.

For the target 1 t1, the above operation to find the conversion factor β value corresponding to the minimum RMSE E value may be performed by the plurality of target candidates t1 . . . tn.

Through this process, a minimum RMSE E value equal to the total number of the targets detected by radar 20 may be obtained.

Referring to FIG. 8(B), the best target A may be automatically determined from the minimum RMSE E value obtained for each target, and the final conversion factor β may be automatically calculated.

As shown in FIG. 8(B), the target corresponding to the smallest RMSE E value of the smallest among them may be automatically determined as the best target (A of FIG. 5, best target of FIG. 8(B)) by comparing the sizes of the minimum RMSE E values corresponding to each of the total targets (S134).

In addition, when the best target A is selected, the conversion factor β corresponding to the minimum RMSE E value of the selected best target A may be automatically calculated as the final conversion factor β to be obtained (S136).

Through the process, the best target A that is most suitable for estimating the radar 20-based structural displacement may be automatically selected through computational processing by the program without human intervention, and the final conversion factor β may be automatically estimated for conversion from the displacement in the line-of-sight direction D of the structure 10 to the displacement in the actual vibration direction u of the structure 10.

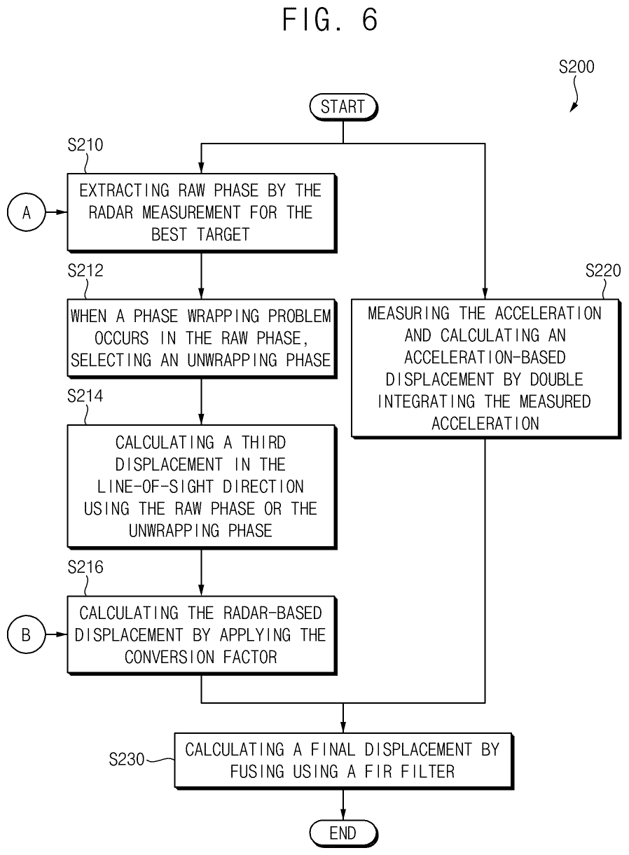

FIG. 6 is a flowchart illustrating the structural displacement monitoring steps included in the method of estimating the displacement of the structure in FIG. 4.

Referring to FIG. 6, the structural displacement monitoring (S200) may first extract the raw phase by measuring the radar for the best target A (S210). If the phase wrapping problem occurs in the extracted raw phase, an unwrapping phase obtained by the phase unwrapping processing may be selected as an actual phase by using the accelerometer 30 auxiliary unwrapping algorithm utilizing the acceleration information (S212). If there is no phase unwrapping problem, the raw phase may be used, and if the phase wrapping problem occurs, the third displacement in the line-of-sight direction may be calculated using the unwrapping phase (S214), and the final conversion factor β obtained in the automated initial calibration step (S100) may be applied to the calculated third displacement to obtain the radar-based displacement in the vibration direction of the displacement measurement point (S216).

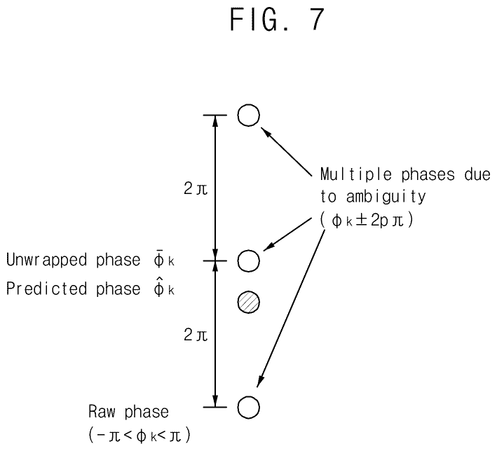

A detailed description of the unwrapping algorithm will be described below with reference to FIG. 7.

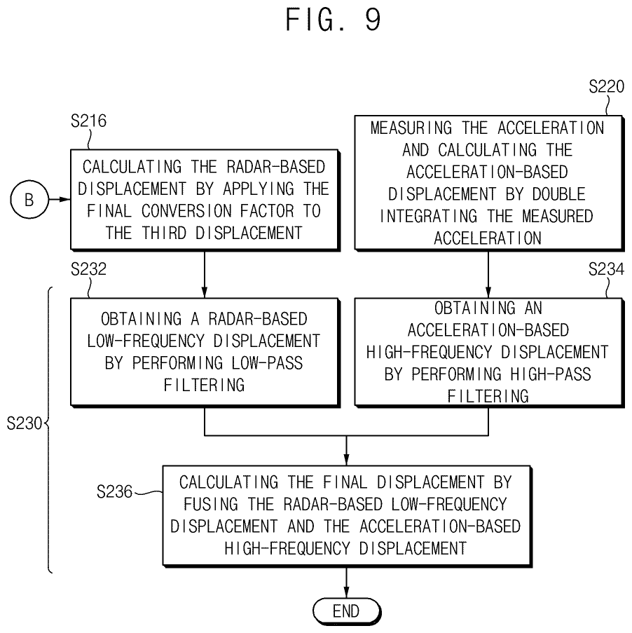

After calculating the acceleration-based displacement by double integrating the acceleration measured by the accelerometer 30 (S220), the final displacement may be calculated by fusing based on the FIR filter the radar-based displacement and the acceleration-based displacement (S230). A detailed description of the final displacement calculation step (S230) will be described below with reference to FIG. 9.

The structural displacement monitoring (S200) may estimate the structural displacement of the structure 10 at a regular interval to monitor its stability, or to estimate the structural displacement in real time if an immediate response is required. At this time, the best target A and its final conversion factor β automatically selected in the automated initial calibration step (S100) may be continued. In other words, the best target A may be selected in the automated initial calibration step (S100), the final conversion factor β for the target may obtained, and then the structural displacement monitoring step may be performed to calculate the displacement of the structure 10 (S200).

FIG. 7 is a view illustrating the accelerometer 30 auxiliary phase unwrapping algorithm applied to the method of estimating the displacement of the structure of FIG. 4.

As shown in FIG. 1, the radar 20 may transmit the frequency modulation signal toward a target and then receives the reflected signal from the target. The displacement estimator 50 may proceed signal processing the reflected signal and extract the raw phase.

Referring to FIG. 7, no matter how much the distance between the radar 20 and the target increases, a phase change Δφ corresponding to the distance change may only output values between −π and π. Therefore, the raw phase extracted through the signal processing may not accurately estimate the distance between the radar 20 and the target, resulting in the large structural displacement estimation error.

Specifically, when the displacement of the displacement measurement point P of structure 10 is greater than the wavelength of the radar 20 signal, the phase wrapping problem may occur. For example, a phase may gradually increase from zero, suddenly decrease to −π as it passes through the π, and then increase again towards the π, causing the phase to be wrapped, requiring phase unwrapping to obtain meaningful information from the wrapping phase.

In an illustrative embodiment, the accelerometer 30-based unwrapping algorithm may be applied to the raw phase obtained from the radar 20 measurements to make further use of the acceleration information. Through this, when the raw phase is unwrapping phase, it may be recovered to the actual phase.

Referring to FIG. 7, the steps of selecting the unwrapping phase will described in detail below.

First, in the kth time step, a predicted displacement (ûₖ) and a predicted phase (\hat{φ}ₖ) may be represented as follows:

$${\hat{u}}_{k} = 2 {u}_{k - 1} - {u}_{k - 2} + {( Δ t )}^{2} {a}_{k - 1} \qquad [ Equation 10 ]$$

$${\hat{φ}}_{k} - 4 π {f}_{s} \frac{{\hat{u}}_{k}}{β c} \qquad [ Equation 11 ]$$

In Equations. 10 and 11, uₖ₋₁, uₖ₋₂ and aₖ₋₁ are a displacement at k−1th and k−2th time steps and an acceleration at k−1th time phase, respectively, Δt is the signal round-trip time, and fₛ, β and c represent the starting frequency of the chirp signal, conversion factor, and speed of light, respectively.

Next, the following round function may be used to select the unwrapping phase (φ̅ₖ) that is closest to the predicted phase (\hat{φ}ₖ) while existing within the range of ±2pπ of the raw phase (φₖ).

$${\overline{φ}}_{k} = {φ}_{k} + 2 π \times round ( \frac{{\hat{φ}}_{k} - {φ}_{k}}{2 π} ) \qquad [ Equation 12 ]$$

Finally, the radar 20-based displacement (uₖ) may be obtained.

$${u}_{k} = β \frac{c}{4 π {f}_{s}} ( {\overline{φ}}_{k} - {φ}_{0} ) \qquad [ Equation 13 ]$$

In Equation. 13, represents the initial phase.

Using the acceleration information as described above, even if the structural displacement greater than the wavelength of radar 20 occurs due to vibration, the displacement of structure 10 may be accurately estimated by selecting the unwrapping phase.

FIG. 9 is a view illustrating the step of fusing based on the FIR filter of FIG. 6 to calculate the final displacement.

Referring to FIG. 9, the steps of calculating the final displacement (S230) may include a step of performing low-pass filtering after obtaining the radar 20-based displacement (S214, S232), performing high-pass filtering after obtaining the acceleration-based displacement (S222, 234), and calculating the final displacement by fusing the radar 20-based low-frequency displacement and the acceleration-based high frequency displacement (S236).

As described above with reference to FIG. 7, the radar 20-based displacement and the accelerometer 30-based displacement may include noise error components. The high-pass filtering may be performed to eliminate a low-frequency noise in accelerometer 30-based displacements (S234). In this process, the low-frequency energy of the actual displacement data cannot be restored, and in order to compensate for this, the displacement may be estimated by fusing the low-frequency displacement based on the radar 20 measurements.

In an illustrative embodiment, the FIR filter may be used for such noise removal. In the FIR filter, the radar 20-based displacement may be obtained by applying the final conversion factor B and the radar 20-based low-frequency displacement may be obtained by the low-pass filtering (S216). In addition, after double integrating the acceleration measurement (S222), the acceleration-based high frequency displacement may be obtained through the high-pass filtering (S234). By fusing the acceleration-based high frequency displacement and the radar (20) based low-frequency displacement thus obtained, the final displacement with improved accuracy may be calculated (S236).

A minimization function may be used to fuse two physical quantities.

$${Π ( {u}^{*} ) = \frac{1}{2} ‖ {L}_{a} {L}_{c} {u}^{*} - {{L}_{a} ( Δ t )}^{2} a ) ‖}_{2}^{2} + \frac{{λ}^{2}}{2} {‖ {u}^{*} - u ‖}_{2}^{2} \qquad [ Equation 14 ]$$

In Equation. 14, Lₐ and L_{c} represent the weighted diagonal matrix and differential operators, respectively, u*, u, a represent a vector representation of the estimated displacement, the radar-measured displacement, and the accelerometer-measured acceleration, and Δt represents the signal round-trip time. The normalization constant λ is defined as 46.81 (2N+1)^{-1.95}.

To summarize, the final displacement (u*ₖ) may be expressed as follows:

$${u}^{*} = {( Δ t )}^{2} {( {L}^{T} L + {λ}^{2} I )}^{- 1} {L}^{T} {L}_{a} a + {{λ}^{2} ( {L}^{T} L + {λ}^{2} I )}^{- 1} u \qquad [ Equation 15 ]$$

$${u}_{k}^{*} = {C}_{H} a + {C}_{L} u \qquad [ Equation 16 ]$$

In Equations. 15 and 16, L=LₐL_{c}, C_{H} is a filter factor applied to the measurement acceleration as the M+1th row of {(Δt)²(L^{T}L+λ²t)⁻¹L^{T}Lₐ}, C_{L} is a filter factor, applied to the radar 20 measurement as the M+1th row of {λ²t(L^{T}L+λ²t)⁻¹}, a is the measurement acceleration vector, and u is the radar 20-based displacement vector. By sacrificing only a small amount of time delay MΔt, we can more accurately estimate the displacement in the kth time step.

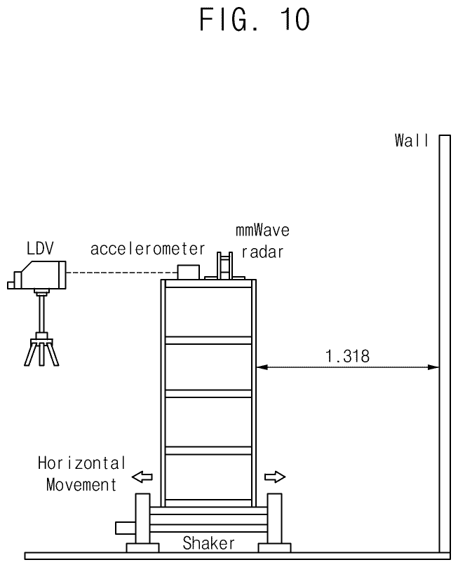

FIGS. 10 to 19 shows an actual experimental verification result of the structural displacement estimation method according to the embodiment of the disclosure and the system using the same.

The actual experiment measured the structural displacement of the bridge, which is caused by large vibrations caused by short-range, long-range, and a pedestrian. Based on the actual displacement (reference, solid line), the estimated structural displacement (hereinafter, “proposed technical displacement”) according to the embodiment of the disclosure and the estimated structural displacement according to the conventional method (hereinafter, “conventional technical displacement”) were calculated together. The conventional technology displacement was estimated after randomly selecting the target and obtaining a conversion factor β2 using a geometric relationship between the radar 20 and the target.

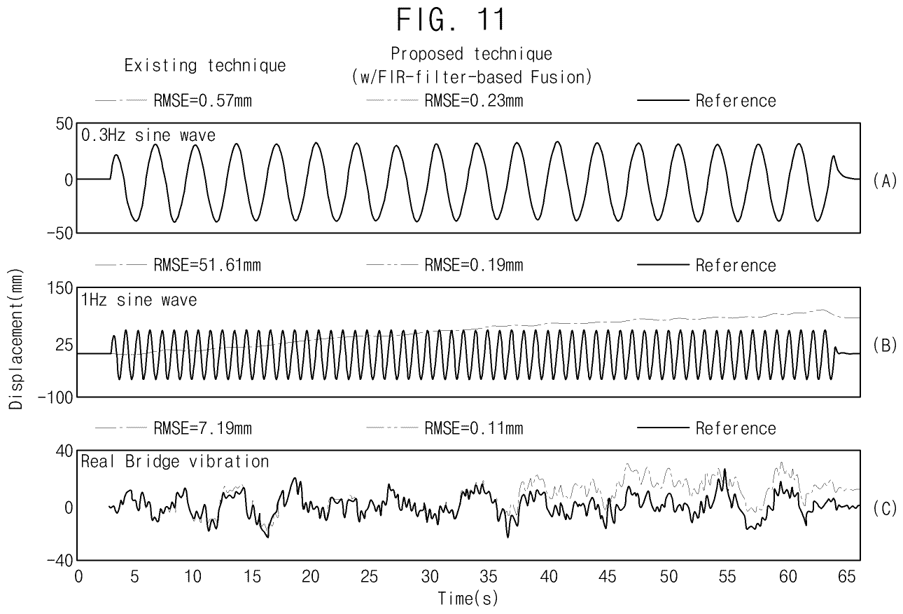

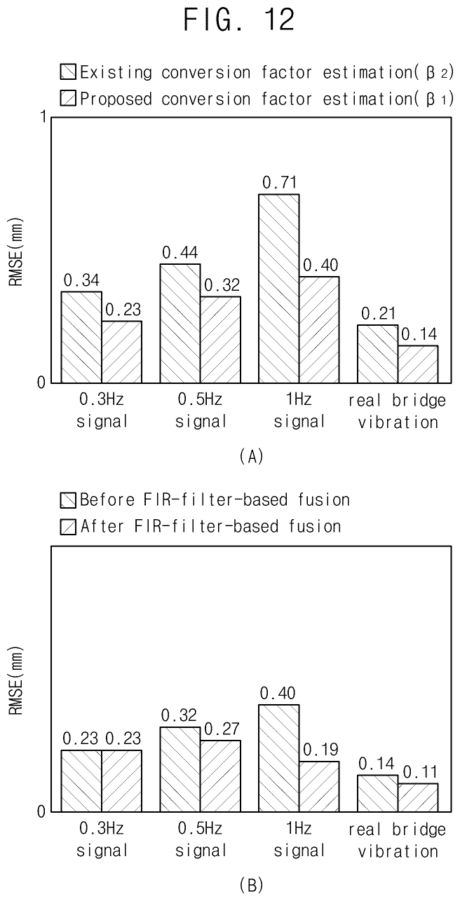

FIG. 10 is a configuration layout for the short-range simulation, FIG. 11 is a view illustrating the estimated displacement according to a vibration magnitude, and FIG. 12 is a result of calculating final conversion factor and an error of the estimated displacement by applying the final conversion factor.

Referring to FIG. 10, the radar 20 and the accelerometer 30 were installed directly on the structure 10, and the LDV was installed on a ground to measure the structure displacement. The structure 10 is designed to vibrate horizontally by a shaker.

Referring to FIG. 11, when the displacement of the displacement measurement point P of the structure 10 is greater than the wavelength of the radar 20 signal, the phase wrapping problem may occur. As shown in FIGS. 11(B) and 11(C), in the bridge where large vibrations (1 Hz sine wave) and actual vibration are caused, the simulation results show that the conventional technical displacement (single point chain line) is phase-wrapped and diverges more than the actual displacement (solid line).

On the other hand, as shown in FIG. 11(A) to 11(C), it may be seen that the proposed technical displacement (advantage chain) is almost identical to the actual displacement (solid line).

Referring to FIG. 12(A), it may be seen that the proposed technical displacement (upward bias) has a 38% reduction in RMSE error compared to the conventional technical displacement (downward bias). The time delay taken to estimate the proposed technology displacement is only 0.5 seconds.

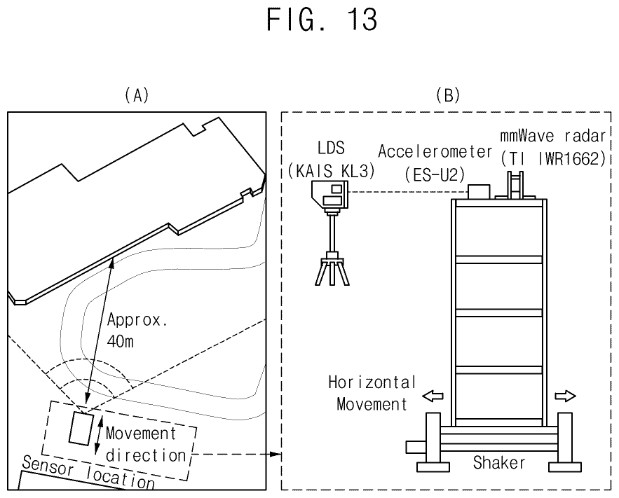

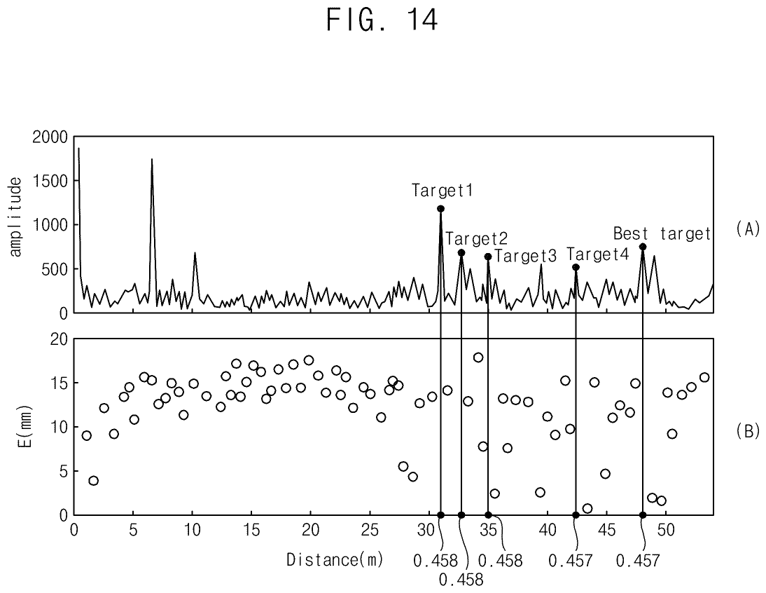

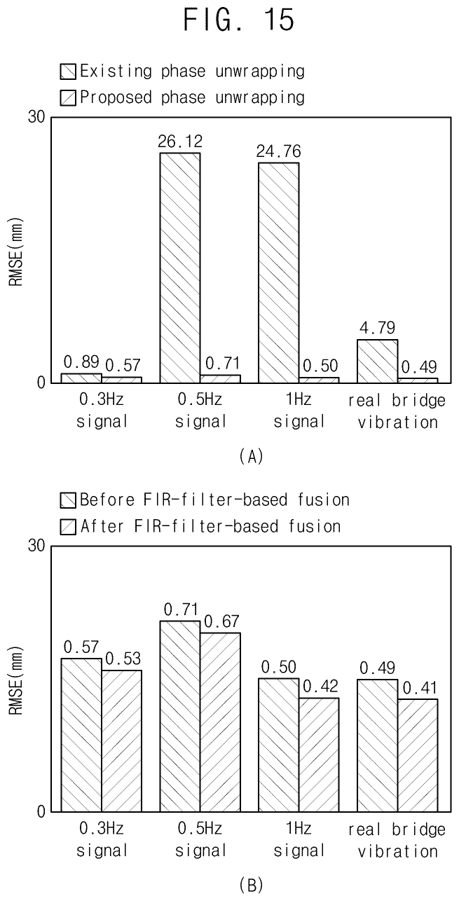

FIG. 13 is a configuration layout for long-range simulation, FIG. 14 is a view illustrating the automated initial calibration step, and FIG. 15 is a calculating result of the unwrapping algorithm and the error of the estimated displacement by applying the unwrapping algorithm.

Referring to FIG. 13, the radar 20 and the accelerometer 30 were installed directly on the structure 10, and the LDS was installed on the ground to measure the structural displacement. The structure 10 is designed to vibrate horizontally by the shaker.

Referring to FIG. 14, the best target with the minimum RMSE E value of 0.457 is automatically determined as the best target A, and the E value of the target of 0.457 is automatically estimated as the final conversion factor B. (It appears that there are targets with the same value in the view as it is only written to three decimal places, however if you find more than four decimal places, you can see that the values are different from each other.)

Referring to FIG. 15(A), when the displacement of the displacement measurement point P of the structure 10 is greater than the wavelength of the radar 20 signal, the phase wrapping problem may occur. Therefore, the conventional technical displacement (downward displacement) may estimate the structural displacement close to the actual displacement only under weak vibrations of about 0.3 Hz.

On the other hand, as shown in FIGS. 15(A) and 15(B), the proposed technical displacement (upward stray) may reduce the displacement estimation error by applying the accelerometer 30 auxiliary unwrapping algorithm to unwrap the wrapped phase as well. As shown in FIG. 15(B), the final displacement calculated based on the FIR filter shows an additional 11% reduction in RMSE error.

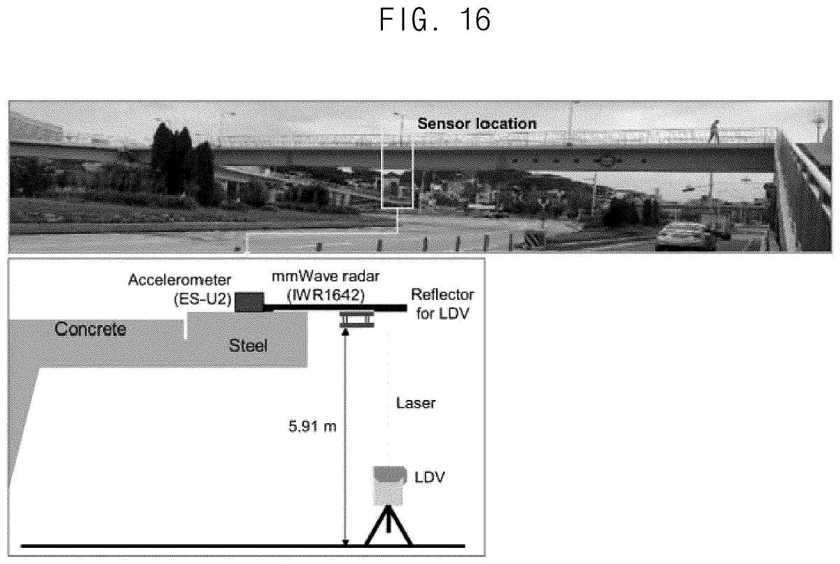

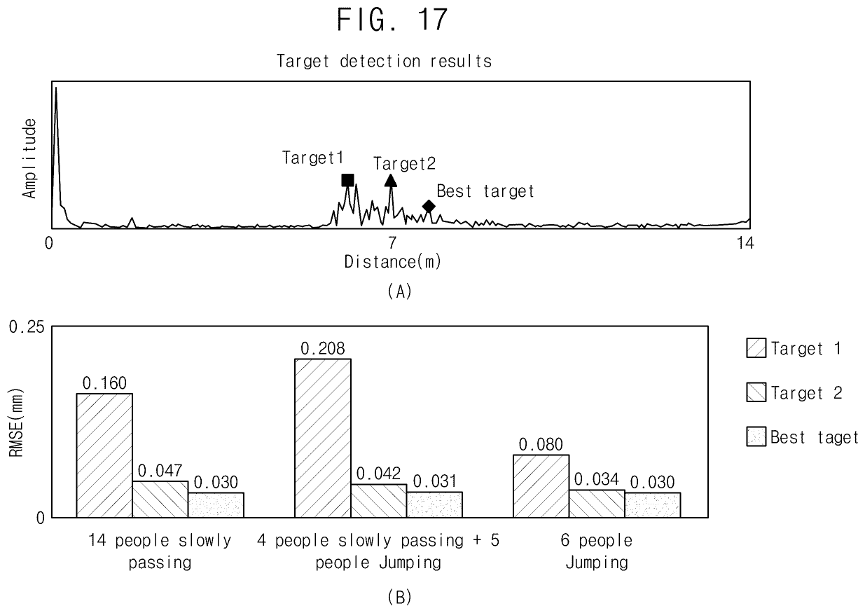

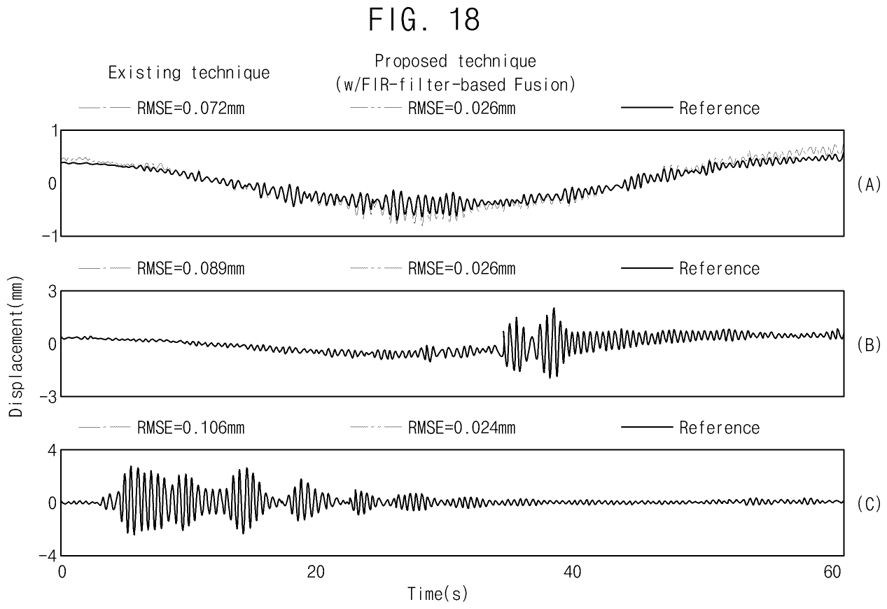

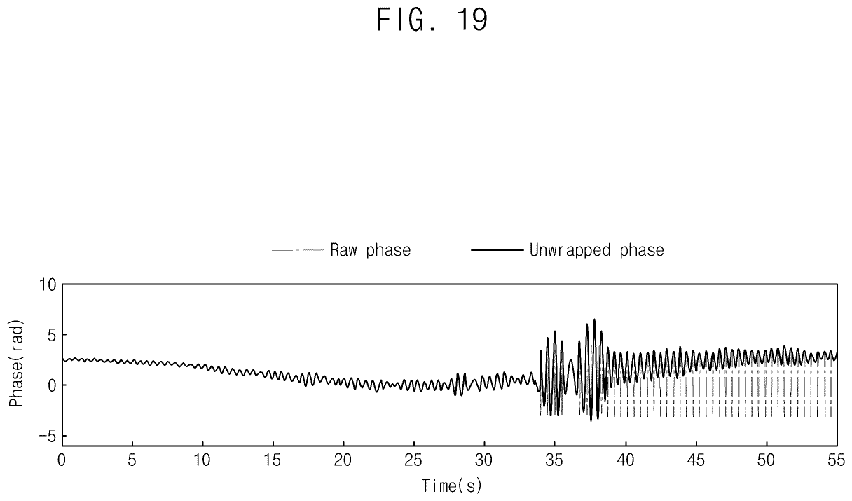

FIG. 16 is a configuration layout for simulation of the structure caused by the walking of the pedestrian, FIG. 17(A) is a view illustrating the automated initial calibration step, FIG. 17(B) is the result of calculating the estimated displacement error for each target, FIG. 18 is a view illustrating the estimated displacement according to the vibration magnitude, and FIG. 19 is a view illustrating the raw phase and unwrapping phase of FIG. 18(B).

Referring to FIG. 16, the radar 20 and the accelerometer 30 were installed directly on the structure 10, and the LDV was installed on the ground to measure the structure displacement.

Referring to FIG. 17(A), the best target is automatically determined to be a target located at a distance of 7 m, as opposed to a target with a maximum amplitude (target 1). Referring to FIG. 17(B), the RMSE error of the structural displacement estimated by the target 1 with the maximum amplitude is up to 0.208 mm, whereas the maximum RMSE error of the proposed technique is only 0.030 mm. In other words, it may be confirmed that the target with the maximum amplitude and the best target are irrelevant.

FIG. 18(A) is a simulation result of 14 people passing slowly over the bridge, FIG. 18(B) is a simulation result of 14 people walking slowly over the bridge and 5 people running at ½ point of the bridge, and FIG. 18(C) a simulation result of 6 people running at ½ of the bridge.

As shown in FIGS. 18(A) to 18(C), it may be seen that as the vibration increases, the RMSE error of conventional technical displacement increases, and the accuracy of the displacement estimation decreases. On the other hand, the maximum RMSE error of the proposed technology displacement is only 0.026 mm, which confirms that the displacement may be estimated more accurately compared to the conventional technique.

Referring to FIG. 19, the raw phase (dotted line) was shown to have a phase wrapping problem after 35 seconds, however, the proposed technical displacement may be estimated to be based on the radar 20 after obtaining the unwrapping phase (solid line) by applying the unwrapping algorithm. Thus, the proposed technical displacement may estimate the structural displacement more accurately than the conventional technical displacement that does not consider the phase wrapping problem.

The structural displacement estimating method according to the embodiment of the disclosure described above may be software implemented in a form of a program instruction that may be carried out through various computer means. The software may include a computer program, code, instruction, or one or more combinations thereof, and may configure the processing device to behave as desired, or may command the processing device independently or collectively. The program command may be recorded on a computer-readable medium. The computer-readable medium may include program instructions, data files, data structures, or the like, these may be used alone or in combination thereof. The program commands recorded in the medium may be designed and constructed specifically for embodiments, or they may be available to a computer software technician. Examples of the computer-readable recording medium may include magnetic media such as hard disks, floppy disks, and magnetic tapes, optical media such as CD-ROMs and DVDs, magneto-optical media such as floptical disks, and hardware devices specifically configured to store and perform program instructions, such as ROMs, RAM, flash memory, and so on.

The computer means for implementing the structural displacement estimation system 1000 and the structure displacement estimation method 2000 according to the embodiments may be implemented using one or more general-purpose computers or special-purpose computers, e.g., processors, controllers, arithmetic logic unit (“ALU”), digital signal processors, microcomputers, field programmable array (“FPA”), programmable logic unit (“PLU”), microprocessor, or any other device capable of executing and responding the instructions.

### INDUSTRIAL APPLICABILITY

The disclosure relates to a structural displacement estimating method and a displacement estimation system for the same, and the measurement information of the accelerometer and the radar sensor installed in the structure to be measured may be used together to improve the accuracy of the displacement measurement.

Although the disclosure will be described in detail above, the scope of the rights of the disclosure is not limited thereto, and the various modifications and improvements of the basic concept of the disclosure defined in the following claims also fall within the scope of the rights of the disclosure.

1. A structural displacement estimation method performed by a computer program running on a computing device, the computer program being configured to cause a processor of the computing device to perform the method, the method comprising:
an automated initial calibration step configured to collect measured values respectively from a radar and an accelerometer installed directly at a displacement measurement point of a structure, automatically determine one best target among a plurality of candidate targets detected by the radar, and automatically calculate a final conversion factor to convert from a displacement in a line-of-sight direction of the displacement measurement point for the best target to a displacement in an actual vibration direction; and
a structural displacement monitoring step configured to calculate a final displacement by fusing based on a FIR-filter a radar-based displacement obtained by applying the final conversion factor to a phase extracted from the measured value from the radar of the best target, and an accelerometer-based displacement obtained by double integrating the measured value from the accelerometer.

2. The structural displacement estimation method of claim 1, wherein the measurement using the radar and the measurement using the accelerometer are carried out for a same period of time.

3. The structural displacement estimation method of claim 1, wherein the measurement using the radar and the measurement using the accelerometer are carried out in less than one minute.

4. The structural displacement estimation method of claim 1,
wherein the radar and the accelerometer are installed in close proximity to each other at the displacement measurement points of the structure and collect the measured values.

5. The structural displacement estimation method of claim 1, wherein the automated initial calibration step comprises:
measuring an initial displacement in the line-of-sight direction of the displacement measurement point for each of the plurality of candidate targets using the radar;
calculating a plurality of first displacements in the vibration direction by applying a plurality of conversion factor values to the initial displacement for each of the plurality of candidate targets;
measuring an acceleration of the displacement measurement point with the accelerometer;
calculating a second displacement by double integrating the acceleration;
calculating RMSE between each of the plurality of first displacements calculated for each of the plurality of candidate targets and the second displacement, and determining a minimum value among the calculated RMSE values as a minimum RMSE value of the candidate target;
automatically determining a candidate target having a smallest minimum RMSE value among the plurality of minimum RMSE values determined for each of the plurality of candidate targets as the best target; and
automatically calculating a conversion factor applied to obtain the minimum RSME value of the best target as a final conversion factor of the best target.

6. The structural displacement estimation method of claim 5,
wherein the plurality of conversion factor values are within a range of 0.5 to 2.0.

7. The structural displacement estimation method of claim 1, wherein the structural displacement monitoring step is periodically performed by performing the displacement measurement periodically using the radar and the accelerometer for the best target automatically determined in the automated initial calibration step.

8. The structural displacement estimation method of claim 1, wherein the structural displacement monitoring step comprises:
extracting raw phase by performing the radar measurement for the best target using the radar;
measuring the acceleration of the displacement measurement point with the accelerometer and calculating the acceleration-based displacement by double integrating the measured acceleration;
when a phase wrapping problem occurs in the raw phase due to the displacement of the displacement measurement point of the structure being greater than a wavelength of a radar signal of the radar, selecting an unwrapping phase close to a predicted phase using the measured acceleration;
calculating a third displacement in the line-of-sight direction using a raw phase without the phase wrapping problem or the unwrapping-processed phase due to phase wrapping problem;
calculating the radar-based displacement in the vibration direction by applying the final conversion factor to the third displacement in the line-of-sight direction; and
calculating the final displacement by fusing the acceleration-based displacement and the radar-based displacement using the finite impulse response (FIR) filter.

9. The structural displacement estimation method of claim 8, wherein the step of calculating the final displacement comprises, obtaining a radar-based low-frequency displacement by performing low-pass filtering on the radar-based displacement, obtaining an acceleration-based high frequency displacement by performing high-pass filtering on the acceleration-based displacement, and calculating the final displacement by fusing the radar-based low-frequency displacement and the acceleration-based high frequency displacement.

10. The structural displacement estimation method of claim 8, wherein the step of selecting the unwrapping phase comprises:
using a displacement at (k−1)th and (k−2)th time steps and a (k−1)th acceleration, each of a predicted displacement (ûₖ) and a predicted phase (\hat{φ}ₖ) at kth time step are calculated by Equation ûₖ=2uₖ₋₁−uₖ₋₂+(Δt)²aₖ₋₁ and Equation
$${\hat{φ}}_{k} - 4 π {f}_{s} \frac{{\hat{u}}_{k}}{β c} ;$$
and
finding an unwrapping phase within the ±2pπ range (where the p is an integer) of the raw phase and closest to the predicted phase by Equation
$${\overline{φ}}_{k} = {φ}_{k} + 2 π \times round ( \frac{{\hat{φ}}_{k} - {φ}_{k}}{2 π} ) ,$$
and selecting as a phase to be used to estimate the radar-based displacement.

11. The structural displacement estimation method of claim 8, wherein the final displacement is calculated using a formula u*ₖ=C_{H}a+C_{L}u(C_{H}: double integration and (2M+1)th order high-pass filter, a: measurement acceleration vector, C_{L}: (2M+1)th order low-pass filter, u: radar-based displacement vector).

12. The structural displacement estimation method of claim 1,
wherein the radar is a frequency modulation continuous wave radar signal (FMCW) millimeter wave radar, and a frequency modulation continuous signal transmits a chirp signal, receives a signal reflected from the target candidate group, and estimates the displacement in the line-of-sight direction using a signal round-trip time between the transmit and receive signals.

13. A structural displacement estimation system comprising:
a radar installed directly at a displacement measurement point of a structure, configured to transmit radar signals toward a plurality of candidate targets that do not change position, and configured to receive reflected signals reflected from the plurality of candidate targets;
an accelerometer installed at the displacement measurement point of the structure and configured to measure acceleration at the displacement measurement point of the structure, and
a displacement estimator configured to perform an automated initial calibration function configured to collect measured values respectively from a radar and an accelerometer, automatically determine one best target among a plurality of candidate targets detected by the radar, automatically calculate a final conversion factor to convert from a displacement in a line-of-sight direction of the displacement measurement point for the best target to a displacement in an actual vibration direction; and a structural displacement monitoring function configured to calculate a final displacement by fusing based on a FIR-filter a radar-based displacement obtained by applying the final conversion factor to a phase extracted from the measured value from the radar of the best target, and an accelerometer-based displacement obtained by double integrating the measured value from the accelerometer.

14. The structural displacement estimation system of claim 13, wherein the displacement estimator includes:
a computer program written to perform the automated initial calibration function and the structural displacement monitoring function; and
a processor executing the computer program.

15. The structural displacement estimation system of claim 13, wherein when a wrapping problem occurs the phase due to a displacement of the displacement measurement point of the structure being greater than a wavelength of the radar signal, the displacement estimator is further configured to perform a phase unwrapping processing function to estimate a radar-based displacement by selecting an unwrapping phase closest to a predicted phase using a measured acceleration at the structure.

16. The structural displacement estimation system of claim 13,
wherein the automated initial calibration function comprises:
a function of measuring an initial displacement in the line-of-sight direction of the displacement measurement point for each of the plurality of candidate targets using the radar;
a function of calculating a plurality of first displacements in the vibration direction by applying a plurality of conversion factor values to the initial displacement for each of the plurality of candidate targets;
a function of measuring an acceleration of the displacement measurement point with the accelerometer;
a function of calculating a second displacement by double integrating the acceleration;
a function of calculating RMSE between each of the plurality of radar-based first displacements calculated for each of the plurality of candidate targets and the second displacement, and determining a minimum value among the calculated RMSE values as a minimum RMSE value of the candidate target;
a function of automatically determining a candidate target having a smallest minimum RMSE value among the plurality of minimum RMSE values determined for each of the plurality of candidate targets as the best target; and
a function of automatically calculating a conversion factor applied to obtain the minimum RSME value of the best target as a final conversion factor of the best target.

17. The structural displacement estimation system of claim 13, wherein the structural displacement monitoring function comprises:
a function of extracting raw phase by performing the radar measurement for the best target using the radar;
a function of measuring the acceleration of the displacement measurement point with the accelerometer and calculating the acceleration-based displacement by double integrating the measured acceleration;
when a phase wrapping problem occurs the raw phase due to a displacement of the displacement measurement point of the structure being greater than a wavelength of the radar signal, a function of selecting an unwrapping phase close to a predicted phase using the measured acceleration;
a function of calculating a third displacement in the line-of-sight direction using a raw phase without the phase wrapping problem or the unwrapping-processed phase due to phase wrapping problem;
a function of calculating the radar-based displacement in a vibration direction by applying the final conversion factor to the third displacement in the line-of-sight direction; and
a function of calculating the final displacement by fusing the acceleration-based displacement and the radar-based displacement using the finite impulse response (FIR) filter.

18. The structural displacement estimation system of claim 13, wherein the function of the calculating the final displacement comprises:
a function of obtaining a radar-based low-frequency displacement by performing low-pass filtering on the radar-based displacement;
a function of obtaining an acceleration-based high frequency displacement by performing high-pass filtering on the acceleration-based displacement; and
a function of calculating the final displacement by fusing the radar-based low-frequency displacement and the acceleration-based high frequency displacement.

19. A computer-executable program stored in a computer-readable recording medium to perform the structural displacement estimation method according to claim 1.

20. A computer-readable recording medium recording a computer-executable program to perform the structural displacement estimation method according to claim 1.
